(19) United States
(12) Patent Application Publication
(10) Pub. No.: US 2026/0162380 A1
(43) Pub. Date: Jun. 11, 2026

(54) SYSTEM AND METHOD FOR PROVIDING A USER WITH ACCESS TO SECURITY THREAT DATA WITHIN A VIRTUAL REALITY ENVIRONMENT

(71) Applicant: CLOUDSEK RESEARCH PTE. LTD., Singapore (SG)

(72) Inventors: Rahul Sasi, Bengaluru (IN); Syed Shahrukh Ahmad, Bengaluru (IN); Nithya Kurian, Kottayam (IN)

(21) Appl. No.: 19/181,251

(22) Filed: Apr. 16, 2025

(30) Foreign Application Priority Data
Apr. 17, 2024 (IN) 202441030901

(51) Int. Cl. G06T 19/00; G06F 3/01; G06F 3/04815; H04L 9/40

(52) U.S. Cl. CPC G06T 19/006; G06F 3/017; G06F 3/04815; H04L 63/1441

(57) ABSTRACT

A system for providing a user with access to security threat data within a virtual reality (VR) environment. The system includes a memory and a processor. The processor is configured to receive security threat data from one or more sources and visually categorize the received security threat data into one or more categories. The processor is configured to generate a three-dimensional (3D) graphical representation of the categorized security threat data in the VR environment, wherein the 3D graphical representations of the security threat data are to be accessed by the user in the VR environment. In addition, the processor is configured to recognize gesture data of the user requiring access to the 3D graphical representation of the security threat data; and establish an interaction of the user with the 3D graphical representation of the security threat data in response to a recognition of a user gesture from the gesture data.

### CROSS-REFERENCE TO RELATED APPLICATIONS

This application claims priority to Indian Patent Application No. 202441030901, filed on Apr. 17, 2024, the disclosure and contents of which are incorporated by reference in their entireties.

### FIELD OF THE INVENTION

The present disclosure relates to virtual reality (VR) environment and more particularly to a method and system for providing a user with access to security threat data within the VR environment.

### BACKGROUND OF THE INVENTION

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

Rapid advancement of technology and digital systems has led to an increase in cyber security threats, making cyber security a critical concern for individuals as well as organizations. The ability to analyze, understand and respond to cyber security threats is essential for ensuring protection of sensitive data.

Traditional approaches to analyze cyber security threats, such as dashboards, reports, and visualization on two-dimensional screens can be difficult for users to understand and interpret the cyber security threats. The traditional approaches often result in data being presented in a static, cluttered, or complex manner, making it difficult for security analysts to access the security threats effectively. Additionally, as volume and complexity of the security threats increase, the security analysts are often having difficulties in processing and interpreting the data.

Generally, artificial intelligence (AI)/machine learning (ML) mechanisms are used in a processing unit to tackle one or more cyber security threats. Conventionally, the processing unit includes a display in which a dashboard indicates information regarding the one or more cyber security threats and how to tackle the one or more cyber security threats. However, the use of display to provide information regarding the one or more cyber security threat is less intuitive and the interaction fails to enhance user experience.

### SUMMARY OF THE INVENTION

The present invention relates to a system and method for providing a user with access to security threat data within a VR environment.

It is an object of the present disclosure to mitigate, alleviate or eliminate one or more of the above-identified deficiencies and disadvantages in the prior art and solve at least the above-mentioned problem.

According to a first aspect, there is provided a system for providing a user with access to security threat data within a virtual reality (VR) environment. The system comprises a memory and a processor. The processor is configured to receive security threat data from one or more sources and visually categorize the received security threat data into one or more categories. The processor is further configured to generate a three-dimensional (3D) graphical representation of the categorized security threat data in the VR environment. The 3D graphical representations of the security threat data are to be accessed by the user in the VR environment. The processor is configured to recognize gesture data of the user requiring access to the 3D graphical representation of the security threat data. In addition, the processor is configured to establish an interaction of the user with the 3D graphical representation of the security threat data in response to a recognition of a user gesture from the gesture data.

In some embodiments, the processor is configured to prioritize security threats from the security threat data based on a predefined criteria. The predefined criteria comprise at least one of: severity of the security threats, frequency, or potential impact, a financial loss calculation for the security threat data. The processor is further configured to generate the three-dimensional (3D) graphical representation of the categorized security threat data as per the prioritized security threats.

In some embodiments, the one or more categories comprises at least one of: source surface-based categorization or attack surface based categorization.

In some embodiments, the processor is configured to compare the user gesture with pre-stored gesture data that is stored in a database and recognize the user gesture upon successful mapping of the user gesture with the pre-stored gesture data. Further, the processor is configured to establish the interaction of the user with the 3D graphical representation of the security threat data in response to the recognition of the user gesture.

In some embodiments, the processor is configured to receive user inputs to select, manipulate and analyze the 3D graphical representation of the security threat data, upon establishment of the interaction, wherein the user inputs comprise voice inputs, gesture inputs, user movement, image or video inputs, and wherein the voice inputs further comprise multi-action voice commands enabling the user to perform multiple operations through a single composite voice instruction.

In some embodiments, the processor is configured to receive user inputs to prioritize the security threats in the 3D graphical representation of the security threat data upon establishment of the interaction, wherein the user inputs comprise voice inputs, gesture inputs, image or video inputs. Further, the processor is configured to generate one or more threat incidents as per the user inputs, wherein the one or more threat incidents are processed for remedial action.

In some embodiments, the processor is configured to transmit feedback to the user in response to the receipt of the user inputs, wherein the feedback is one of: a voice feedback or a visual feedback, and wherein the feedback comprises a response to a user's query, lack of clarity in the user inputs, or additional user inputs required to establish the interaction.

In some embodiments, the user gestures, for selecting, zooming, and rotating the 3D graphical representations, comprise one or more of: grasping/grabbing, pinching, swiping, rotating hand/wrist and/or pointing gestures.

According to a second aspect there is provided a method for providing a user with access to security threat data within a virtual reality (VR) environment through a processor. The method comprises receiving security threat data from one or more sources and visually categorizing the received security threat data into one or more categories. The method further comprises generating a three-dimensional graphical representation of the categorized security threat data in the VR environment. The 3D graphical representations of the security threat data are to be accessed by the user in the VR environment. In addition, the method comprises recognizing gesture data of the user requiring access to the 3D graphical representation of the security threat data. Furthermore, the method comprises establishing an interaction of the user with the 3D graphical representation of the security threat data in response to a recognition of a user gesture from the gesture data.

According to a third aspect, there is provided a computer program product comprising instructions stored therein, which when executed, causes the processor of the system to perform corresponding steps of method for providing a user with access to security threat data within a virtual reality (VR) environment.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF ACCOMPANYING DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates a network implementation of a system for providing a user with access to security threat data within a virtual reality (VR) environment, according to some embodiments of the invention;

FIG. 2 illustrates a block diagram of the system for providing the user with access to the security threat data within the VR environment, according to some embodiments of the invention;

FIG. 3 illustrates a flowchart illustrating example method steps of a method performed by the system for providing the user with access to security threat data within the VR environment, according to some embodiments of the invention;

FIGS. 4A and 4B illustrate three-dimensional (3D) graphical representation of the security threat data in the VR environment, according to some embodiments of the invention;

FIG. 5 illustrates a virtual interface for establishing an interaction in the VR environment through the system, according to some embodiments of the invention;

FIG. 6 illustrates a three-dimensional (3D) model for establishing interaction in the VR environment through the system, according to some embodiments of the invention;

FIG. 7 illustrates a threat graph for establishing interaction in the VR environment through the system, according to some embodiments of the invention; and

FIG. 8 discloses an example of a computing environment, according to some embodiments of the invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The terms “cyber security threats” and “security threats” as used herein context of the present disclosure are interchangeably used. Further, the terms “cyber security threat data” and “security threat data” as used herein context of the present disclosure are interchangeably used.

The present invention provides a system and a method for providing a user with access to security threat data within a virtual reality (VR) environment.

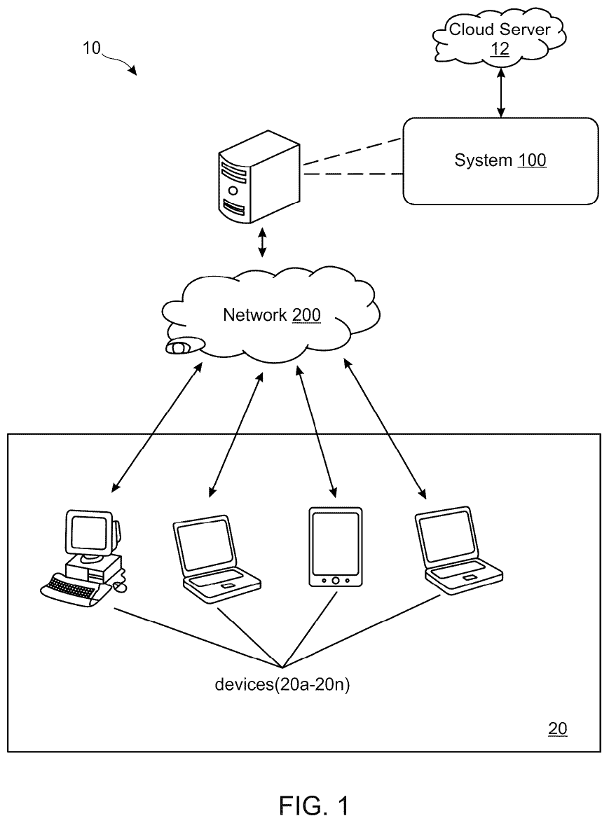

FIG. 1 discloses a network implementation 10 of a system 100 (also may referred to as a VR system) arranged to communicate with a cloud server 12 and a plurality of devices 20a-20n. The plurality of devices 20a-20n are configured to communicate with each other via a network 200. The network implementation 10 further includes a server (not shown) connected to the system 100. The server may be further connected to the plurality of devices 20a-20n through the network 200. The system 100 is used for providing a user interface for interacting with cyber security threat data (or security threat data).

It may be understood that the server, the system 100, and the plurality of communication devices (20a-20n) correspond to computing devices. It may be understood that the server (local server/remote/server/cloud server) may also be implemented in a variety of computing systems such as, a laptop computer, a desktop computer, a notebook, a workstation, a mainframe computer, a network server, a cloud-based computing environment, or a smart phone, and the like. It may be understood that the system 100 may correspond to a variety of portable devices. Further, it may be understood that the system 100 may be, but not limited to, power saving devices.

In an example implementation, the network 200 may be a wireless network, a wired network, or a combination thereof. The network 200 can be implemented as one of the different types of networks, such as intranet, Local Area Network, LAN, Wireless Personal Area Network, WPAN, Wireless Local Area Network, WLAN, wide area network, WAN, the Internet, and the like. The network 200 may either be a dedicated network or a shared network. The shared network represents an association of the different types of networks that use a variety of protocols, for example, MQ Telemetry Transport, MQTT, Extensible Messaging and Presence Protocol, XMPP, Hypertext Transfer Protocol, HTTP, Transmission Control Protocol/Internet Protocol, TCP/IP, Wireless Application Protocol, WAP, and the like, to communicate with one another. Further, the communication network 200 may include a variety of network devices, including routers, bridges, servers, computing devices, storage devices, and the like.

In accordance with the embodiments disclosed herein, the server is configured for establishing the communication between the system 100 and the plurality of communication devices 20a-20n. For example, the server is configured to receive cyber security threat data from a plurality of sources through the device 20a-20n.

Further, a cloud server 12 is configured to receive various parameters from the system 100 and process the various parameters regarding the plurality of devices 20a-20n configured in the system 20 using the machine learning model and AI algorithms.

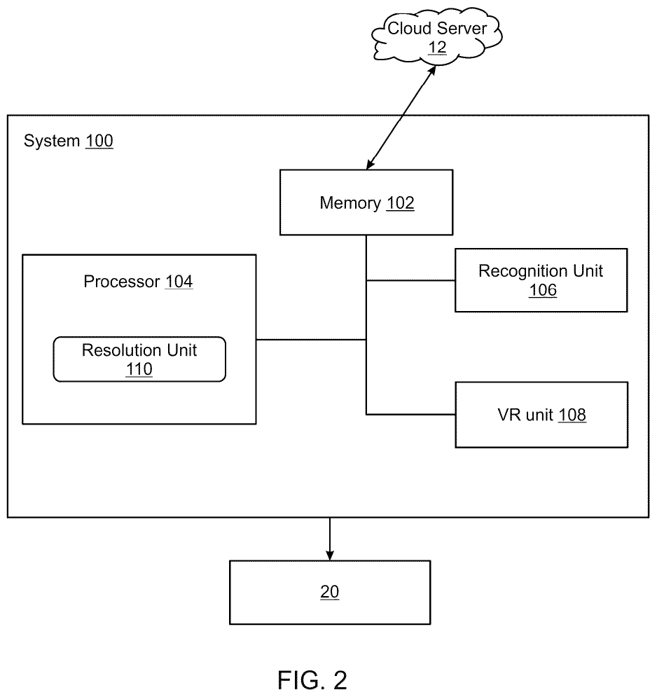

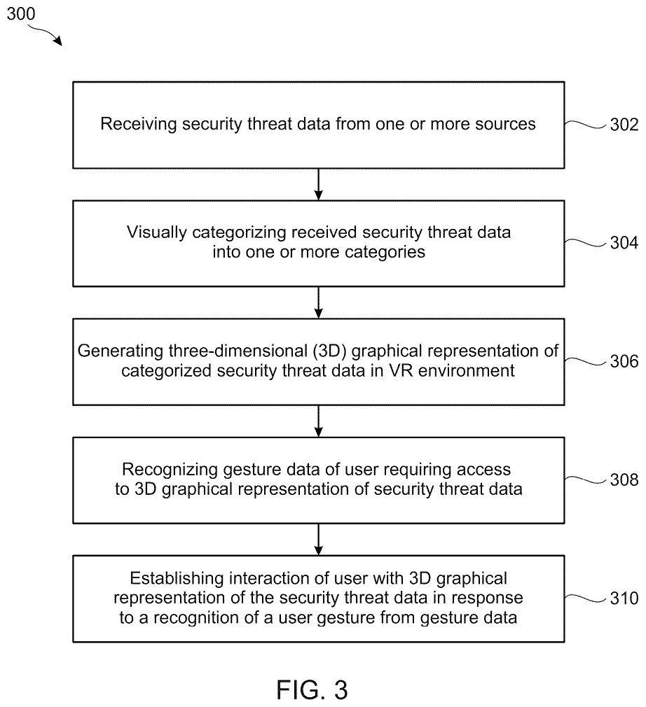

FIG. 2 is an example block diagram of the system 100. The system 100 is configured to execute a method 300 (as depicted in FIG. 3) for providing a user with access to security threat data within a virtual reality (VR) environment. The system 100 in FIG. 2 comprises one or more modules. The one or more modules may comprise a memory 102, a processor 104, a recognition unit 106 and a VR unit 108. The processor 104, memory 102, the recognition unit 106, and the VR unit 108 may be operatively connected to each other.

The memory 102 is arranged to store a plurality of instructions to be executed by the processor 104. The memory 102 may include any computer-readable medium or computer program product known in the art including, for example, volatile memory, such as Static Random-Access Memory, SRAM, and Dynamic Random-Access Memory, DRAM, and/or non-volatile memory, such as Read Only Memory, ROM, Erasable Programmable ROM, EPROM, Electrically Erasable and Programmable ROM, EEPROM, flash memories, hard disks, optical disks, and magnetic tapes. The processor 104 is configured to execute the plurality of modules. A controlling circuitry (not shown in FIG.) may be adapted to control the steps as executed by the processor 104.

The processor 104 is configured to receive security threat data from one or more sources. In an example, the one or more sources may include and not limited to deep web, discussion forums, code platforms, etc. The processor 104 is further configured to visually categorize the received security threat data into one or more categories. The one or more categories may include, but not limited to, source surface-based categorization or attack surface-based categorization. The categorization is done based on the one or more of: source surface or attack surface of the identified security threat. In an example, in the source-based categorization the security threat data (also referred to as threats) are categorized according to their source, such as: deep web, discussion forums, code leaked on code platforms, etc. The threats originating from the deep web where illegal or malicious activities are discussed are categorized under deep web category. In an example, information from forums discussing exploits, vulnerabilities, or potential attack vectors is categorized under discussion forums category. Similarly, threats identified from code leaks on various code-sharing platforms are categorized under code leaked on code platforms category.

In an example, in the attack surface-based categorization, the security threats data (threats) are categorized based on their impact area, such as: network-level attacks, application-level attacks, etc. In some examples, the threats targeting network infrastructure, including DDoS attacks and port scanning are categorized under network-level attacks whereas the threats targeting application vulnerabilities, such as web application attacks are categorized under application-level attacks.

The processor 104 is further configured to generate a three-dimensional 3D graphical representation of the categorized security threat data in the VR environment. The 3D graphical representations of the security threat data are to be accessed by the user in the VR environment. The processor 104 is further configured to recognize gesture data of the user requiring access to the 3D graphical representation of the security threat data and establish an interaction of the user with the 3D graphical representation of the security threat data in response to a recognition of a user gesture from the gesture data. In an example, the user gestures for selecting, zooming, rotating the 3D graphical representations may include and not limited to one or more of: grasping/grabbing, pinching, swiping, rotating hand/wrist, pointing, or opening and closing of palm. For instance, opening the palm may be used to project or summon a Threat Graph, while closing the palm may be used to dismiss or retract it from view. The processor 104 is configured to compare the user gesture with pre-stored gesture data that is stored in a database. The processor 104 is configured to recognize the user gesture upon successful mapping of the user gesture with the pre-stored gesture data. The memory unit 102 stores the pre-stored gesture data related to the security threat data. Once the processor 104 has recognized the user gesture, the interaction of the user with the 3D graphical representation of the security threat data is established.

In some embodiments, successful mapping of the user gesture with the pre-stored gesture data comprises determining the match between the user gesture and one or more pre-stored gestures stored in the database. Further, in an example, the pre-stored gesture data may comprise pre-defines gestures stored in the database.

In some embodiments, pinching may comprise selecting or confirming an action. Further, grabbing/grasping may comprise moving objects within the VR environment. In addition, opening the palm may comprise summoning or displaying a 3D graphical representation, while closing the palm may comprise dismissing or hiding the representation from the user interface. Further, pointing at a gesture may comprise highlighting or selecting objects. Swiping may comprise scrolling through menus or lists. Furthermore, rotating hand/wrist may comprise rotating selected objects. Embodiments of the present disclosure are intended to include and/or otherwise cover any type of gesture that facilitates interaction of the user with the 3D graphical representation without deviating from the scope of the present disclosure.

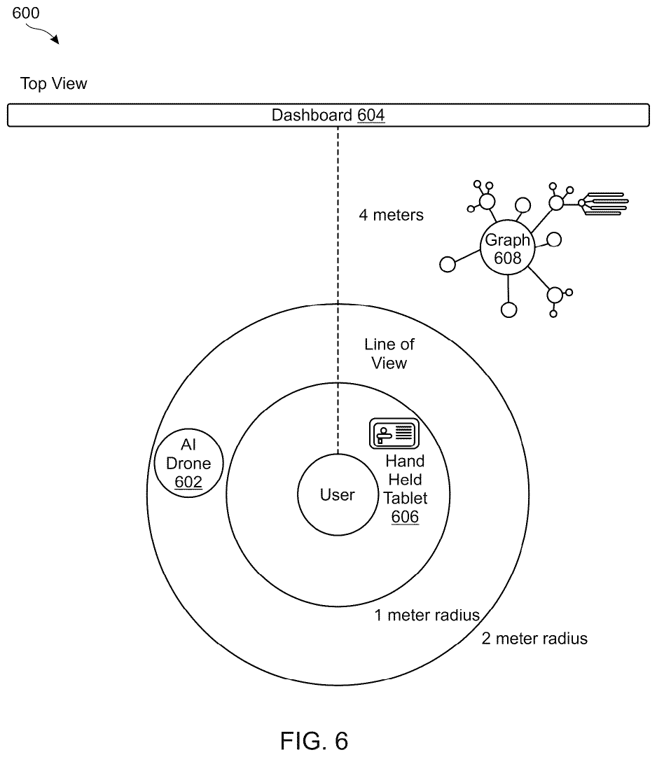

In some embodiments, the processor 104 is configured to receive user inputs to select, manipulate and analyze the 3D graphical representation of the security threat data, upon establishment of the interaction, wherein the user inputs comprise voice inputs, gesture inputs, user movement, image or video inputs, and wherein the voice inputs further comprise multi-action voice commands enabling the user to perform multiple operations through a single composite voice instruction, the operations comprising at least querying for threat severity, while simultaneously initiating a zoom action and/or filtering based on attack surface type. In an example, the user inputs may include and not limited to voice inputs, gesture inputs, user movement, image or video inputs. In an example, the user may provide input to the system 100 through an Artificial Intelligence (AI) drone, which is described later in FIG. 6.

The processor 104 is also configured to prioritize security threats from the security threat data based on a predefined criteria. In an example, the predefined criteria may include severity of the security threats, frequency, or potential impact, a financial loss calculation for the security threat data. The processor 104 may generate the 3D graphical representation of the categorized security threat data as per the prioritized security threats.

In an example, the processor 104 is configured to receive user inputs to prioritize security threat in the 3D graphical representation of the security threat data upon establishment of the interaction, wherein the user inputs comprise voice inputs, gesture inputs, image or video inputs. Further, the processor 104 is configured to generate one or more threat incidents as per the user inputs. The one or more threat incidents are further processed for remedial action.

In some embodiments, the processor 104 is configured to transmit feedback to the user in response to the receipt of the user inputs, wherein the feedback is one of: a voice feedback or a visual feedback. In an example, the feedback may include: a response to a user's query, a lack of clarity in the user inputs, or additional user inputs required to establish the interaction, etc. In another example, the feedback may comprise ambiguous commands and successful commands. The ambiguous commands may comprise statements like “Command unclear, please repeat.”. Further, the successful commands may comprise visually highlighting including changes in the graph, surrounding 3D environment, and audio acknowledgment confirming successful actions.

In an example, the system 100 includes a voice command integration unit (not shown in FIGs.) that allows the users to interact with the application through spoken commands. The system 100 is configured to process advanced natural language, and hence, the system 100 can understand and execute commands spoken in natural language, from simple navigation requests to complex queries. Thus, the system 100 enhances accessibility and enriches the user experience by allowing hands-free interaction and multitasking within the virtual space.

In an example implementation, processing of the voice commands by the system 100 is described now. The voice commands can be processed by active voice listening process or on-demand listening process. In the active voice listening process, the voice command integration unit continuously listens for keywords (For example, active voice listening is triggered with “hey nexus”). The on-demand listening process is activated in response to the user interaction (e.g., activated through UI button press or gaze interaction (new SDK implementation is in the roadmap). In an example implementation, after Voice-to-Text service converts spoken commands to texts, the texts are sent to a backend service for processing. The commands may be classified into UI interaction commands and data commands. In an example, the UI interaction commands comprise move commands, scale commands, rotate commands, and visibility commands. Further, in an example, the data commands (also known as data queries) comprise queries about security threats, incidents, events, and modules. In an example, the command “Bring the graph to me” involves moving the 3D graphical representation of the categorized security threat data closer to the user. The system 100 may calculate the necessary position and rotation changes and apply them. The flow for processing voice command comprises Voice-to-Text to LLM interpretation to actionable VR response.

In an embodiment, the recognition unit 106 is arranged to recognize the user gestures performed by the user and facilitate interaction and resolution of the security threat data in the VR environment. In an example, the system 100 recognizes one or more hand gestures performed by the user to manipulate virtual representations of the security threat data. In addition, the system 100 allows for selecting and examining the security threat data by recognizing a specific user gesture with one or more commands to retrieve more data.

Further, the system 100 includes a resolution unit 110 which is arranged to initiate a resolution action based on the security threat data. In an embodiment, the user interacts directly with one or more threat incidents through gestures or voice commands. Further, the resolution unit 110 updates incident status in real-time based on these interactions. For example, the user selects a threat incident, initiates resolution via voice or gesture, and the system 100 tracks updates accordingly.

Furthermore, the system 100 may include a VR incident management interface (not shown in Figs.). The VR incident management interface may include a network of incidents related to the security threat data with varying one or more attributes, and hence, the system 100 allows the use of the user gestures to organize, prioritize, and address the security threat data. In addition, the system 100 includes the VR unit 108 configured to provide a real-time visual and haptic feedback to the user corresponding to the interaction with one or more virtual elements, ensuring reception of clear and intuitive command inputs from the user. In an example, the user gestures include one or more of: pointing, grabbing, swiping, and other motions to interact with the VR incident management interface. This direct interaction enhances user experience, making it more intuitive and engaging compared to traditional displays and touch-sensitive displays. Therefore, the system 100 provides a natural and efficient method for a cyber security operations management.

The VR incident management interface allows the user to create incidents (tickets) directly within the VR environment. When the security threat from the security threat data is identified, the user can select the security threat using the 3D graph to highlight the specific threat or event. The user also can generate an incident ticket by interacting with VR controls, which includes providing details and assigning it to appropriate analysts. The incident is then automatically passed to an analyst for resolution. This process streamlines the identification and remediation of risks by enabling immediate action and clear visualization of the threat landscape, ensuring faster and more efficient response times.

In an example implementation, the system 100 may execute a passthrough technology configured to integrate live video from the user's environment into an augmented reality (AR) experience. The aforementioned integration allows for a seamless overlay of digital content, such as interactive dashboards and visualizations, directly onto the physical world, maintaining user connection to their surroundings while interacting with virtual elements.

In addition, leveraging the passthrough technology, the system 100 enables the user to interact with complex data visualizations and dashboards in physical space. Interactive gestures and natural movements allow the user to navigate, manipulate, and engage with digital information as if it were a part of their immediate environment, enhancing comprehension and user experience in cyber security applications. In an embodiment, the passthrough technology seamlessly integrates real-world visuals with virtual threat data.

In an example, the system 100 is developed for a Meta Quest 3 platform to deliver a high-quality augmented reality experience. Further, the system 100 prioritizes scalability and adaptability. This allows for seamless integration with new devices and platforms as they emerge. The strategic use of cross-platform development tools and a modular design approach enables system 100 to expand its support to include emerging hardware such as Vision OS, without compromising the system's 100 performance or user experience. This foresight in development strategy positions the system 100 as a versatile and forward-looking solution in the rapidly evolving landscape of mixed reality technologies.

Further, the system 100 may utilize a graphics engine (not shown in FIGs.) in conjunction with augmented reality (AR) foundation to create a unified development environment for its augmented reality application. This combination enables an immersive AR experience that is both feature-rich and performant across diverse devices 20a-20n. Employing the graphics engine, paired with the AR Foundation's ability to offer a standardized application-programming interface (API) that functions across multiple AR platforms, empowers the user to develop a highly versatile application. Hence, the application is fine-tuned for the primary platform, for example, Meta Quest 3. In addition, the application is also poised for straightforward adaptation and expansion to accommodate future platforms and technological advancements. The use of the graphics engine underscores the project's commitment to fostering innovation, ensuring scalability, and enhancing user experience in mixed-reality environments.

In another example implementation, an asset creation workflow is used for the system 100. The system 100 includes a comprehensive process that bridges initial design concepts to a final integration within the augmented reality environment. Further, the workflow begins with the conceptualization and design phase, in which the assets including 3D models, textures, and UI elements are envisioned and created using design tools. In addition, after the design phase, the assets undergo a rigorous preparation phase to ensure they are optimized for real time performance within a graphics engine environment, maintaining fidelity without compromising performance of the system 100.

Subsequently, the prepared assets are imported into an AR development framework, which is facilitated by the AR foundation, which bridges the graphics engine and the application's AR functionalities. This integration phase is critical, as it involves fine-tuning the assets within the application context, ensuring seamless interaction and visual coherence in the mixed reality space.

The system 100 achieves an effective blend of art and technology, paving the way for future advancements in mixed-reality asset creation. Furthermore, in another example implementation, the system 100 elevates user interaction within augmented reality by integrating gesture-based controls and voice command capabilities. This dual-modality approach allows users to navigate, select, and manipulate virtual elements with intuitive hand gestures, providing a natural and immersive way to interact with the AR environment. The system 100 includes the recognition unit 106 that interprets user movements, translating them into in-app actions for a seamless user experience. In addition, the system 100 includes the voice command integration unit that allows users to interact with the application through spoken commands.

The gesture-based controls and voice command integration in combination represent a comprehensive approach to human-computer interaction in AR and hence making the system's 100 user interface intuitive and user-friendly. The abovementioned combination ensures that users can engage with digital content in a manner that feels both natural and effortless, setting a new standard for interactivity in mixed-reality applications.

In an example implementation, the system 100 incorporates a voice command integration system. The voice command integration system combines command-based voice recognition with natural language understanding (NLU) to offer a flexible and intuitive user interface. The system 100 is configured to recognize and interpret a wide array of predefined commands as well as understand and process user queries formulated in natural language.

Further, command-based voice recognition allows for a quick execution of specific functions within the system 100, and hence, enabling users to interact with the system 100 through simple, direct commands. Further, the command-based voice recognition significantly enhances the efficiency of user interactions, streamlining navigation and access to information within the augmented reality environment. Simultaneously, the integration of natural language understanding allows the system 100 to comprehend and act upon user instructions given in conversational language. This makes the system 100 more accessible to users by accommodating a variety of speech patterns and terminologies. Further, the integration of natural language understanding also enriches the interactive experience by allowing more complex queries and commands to be executed seamlessly. The voice command integration system ensures that system 100 provides an exceptionally user-friendly interface, facilitating a more natural and engaging interaction between the user and the AR application.

Furthermore, in another example implementation, the recognition unit 106 may include a gesture recognition unit which is arranged to manage one or more cyber security threats. The gesture recognition unit enables users to interact directly with cyber threat data within the AR environment, using intuitive hand gestures for manipulation and resolution of incidents. In an example, the users can select, navigate, and dissect complex cyber threat information through simple gestures, transforming the cyber security management process into an interactive and engaging experience. The use of the gesture recognition unit accelerates the incident response times and enhances the accuracy and efficiency of threat analysis and resolution.

In another example implementation, in addition to the gesture recognition unit, the system 100 includes the VR unit 108 to provide the users with immediate visual and haptic feedback, ensuring a tangible sense of engagement with the virtual environment. Real-time visual feedback allows users to see the impact of their actions directly within the AR space, offering a clear and immediate understanding of cyber threat data manipulation. Haptic feedback further enriches this interaction by providing tactile responses to gestures, offering an added layer of immersion and intuitiveness. The gesture recognition unit and the VR unit 106 in combination ensure a highly responsive and immersive user experience, making cyber security tasks more intuitive and effective.

FIG. 3 represents a flowchart illustrating example method steps of a method 300 executed by the system 100.

The order in which the steps of the method 300 is described is not intended to be construed as a limitation, and any number of the described method steps may be combined in any order to implement the method 300 or alternate methods. Additionally, individual steps may be deleted from the method 300 without departing from the scope of the invention as defined in the claims.

At step 302, the method 300 comprises receiving security threat data from one or more sources.

At step 304, the method 300 comprises visually categorizing the received security threat data into one or more categories.

At step 306, the method 300 comprises generating the 3D graphical representation of the categorized security threat data in the VR environment. The 3D graphical representations of the security threat data are to be accessed by the user in the VR environment.

At step 308, the method 300 comprises recognizing the gesture data of the user requiring the access to the 3D graphical representation of the security threat data.

At step 310, the method 300 comprises establishing the interaction of the user with the 3D graphical representation of the security threat data in response to the recognition of the user gesture from the gesture data.

The additional details of the method 3000 are similar to the details of the system 100 and hence are not repeated for the sake of brevity.

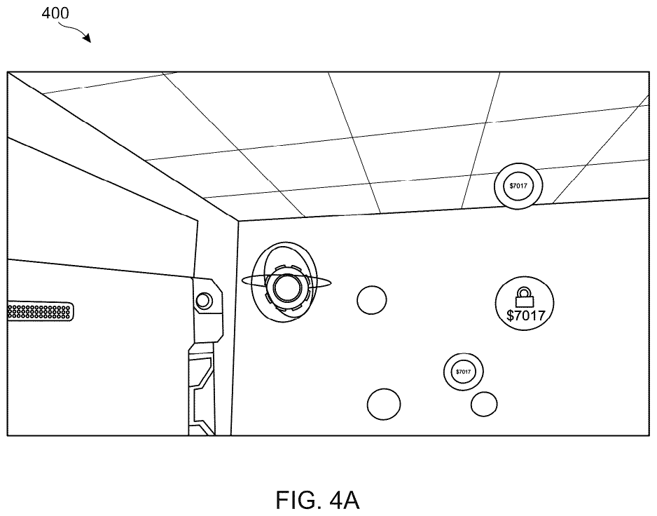

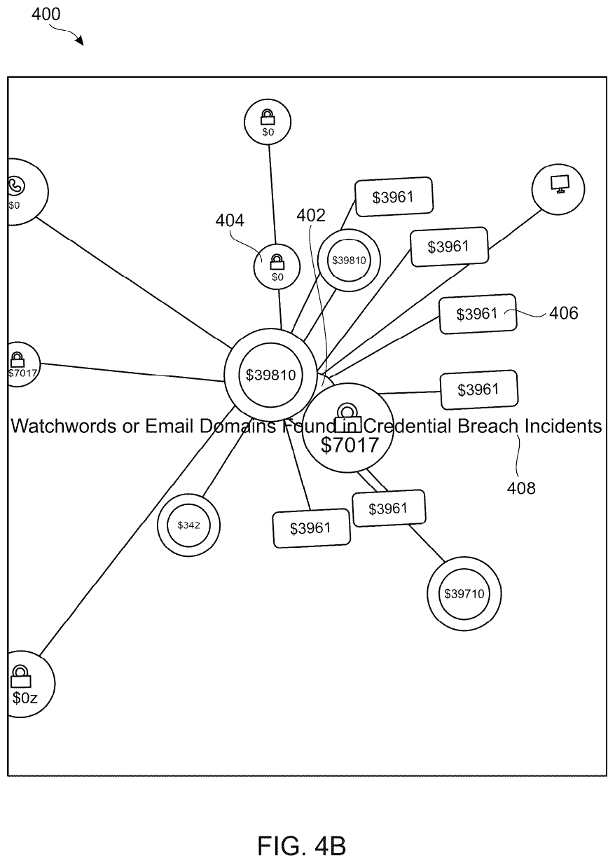

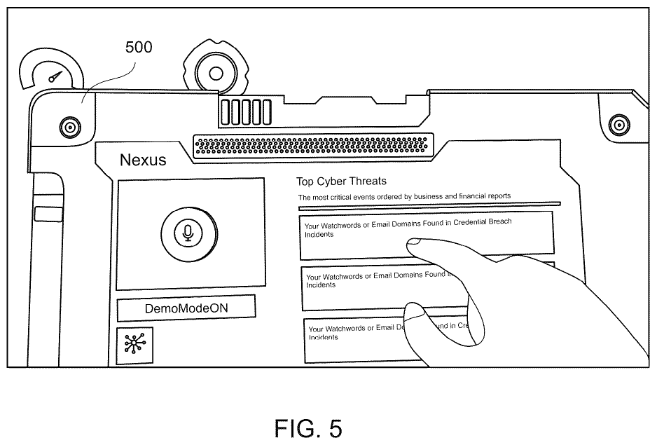

Referring to FIGS. 4A, 4B and 5 in combination, FIGS. 4A and 4B illustrate example diagrams showing 3D graphical representation 400 of the security threat data in the VR environment. The VR interface of the system 100 (as described in FIG. 1) provides an immersive and interactive environment for businesses to quantify the security threat data and assess costs, allowing users to visualize complex data in 3D by providing an immersive and interactive environment for businesses to quantify the security threat data and assess costs without space constraints. As shown in FIG. 4A, in the VR environment, the user can visualize complex data in 3D, making it the perfect platform to handle extensive data sets (hundreds/thousands of incidents/events).

In an example embodiment, a process for setting up an account on a VR device for the user to access the security threat data in the VR environment is described now. At a first step, the user can initiate a login process on a VR headset through an application. To get an organization's data into the application, the user may go through a login process, which can be done by using a Virtual private network (VPN)/proxy to access internal endpoints for the organization's data or implementing the same login process as the web or by using a QR code scan or numeric code to synchronize the login to the VR device. After starting the application, initial Application Programming Interface (API) calls are made to fetch the organization's data. Once the data is loaded, the user can begin interactions with the security threat data. In an example, the system 100 provides real-time smooth interaction via backend API data loading.

The application guide users to interact in the VR environment through at least one of the user interface, gestures, audio/speech, two-dimensional screen/panels, 3D graphs and/or voice commands. The user interface can include and is not limited to buttons, text, and images. The audio/speech may include and is not limited to voice (TTS service). The two-dimensional screen/panels may include a dashboard. The 3D graphs and elements display the organization's data. The users may use voice commands to interact with the security threat data.

Once the login data is synchronized to the VR device, the pass-through technology is enabled, and the user can see their environment and prompt the user to begin the application. An interactive UI (a virtual interface or a virtual handheld tablet as shown in FIG. 5) may be placed at a reachable distance, prompting the user to start with text (“Press the Start button or say Hey User”) and a button labeled “Start.” Upon clicking the button, the main dashboard panel and an organization node will appear, and the user can start interacting with the dashboard and the 3D graph of the security threat data.

In an example, the dashboard UI and content will be the similar to a web page, displaying dollar value, event count, top cyber threats, and GTI feeds.

As shown in FIG. 4B, the 3D graphical representation 400 of the categorized security threat data are displayed in the VR environment. The 3D graphical representation 400 may display as an organizational node (org node) 402, one or more modules 404, one or more incidents 406 and/or one or more events 408. In an example, the organizational node 402 may be placed at center and the one or modules may be placed around the org node 402. The incidents 406 may be plotted around the modules and the events 408 may be popped up around the incidents 406. All nodes in the 3D graphical representation 400 may vary in size, color, and design, connected by lines. Further, selected node lines may be highlighted and animated. In addition, in an example, the organizational node 402 may collapse/expand on the basis of user interaction.

As shown in FIG. 5, the virtual interface 500 (virtual dashboard UI 500) for establishing an interaction in the VR environment, according to some embodiments of the invention. In an example, the virtual handheld device may display, voice command button to activate/deactivate listening, voice command response text, overview of top incidents and their events, demo mode button to adjust passthrough opacity (fully virtual at 0% opacity), passthrough opacity slider to adjust the opacity, and/or reset graph button. In an example, the demo button and the reset graph button may be referred to as quick action buttons.

FIG. 6 illustrates an example diagram showing a three-dimensional (3D) model 600 for establishing interaction in the VR environment. In an example, the three-dimensional (3D) model 600 may include an Artificial Intelligence (AI) assistant drone 602. The AI assistant drone 602 in the application is configured to provide user input to the system 100 and to assist the user. The AI assistant drone 602 follows the user, provides instructions, and takes voice commands in natural language. It enhances the interactive experience by pointing to the required data, managing UI controls, and giving visual feedback while processing voice commands.

In an example, the AI drone 602 (alternatively termed as, AI assistant drone) is programmed to maintain a specific distance range from the user as shown in FIG. 6, with a minimum of 1 meter and a maximum of 2 meters and provide visual/auditory feedback. If the user moves outside the specific distance range, the drone may hover towards the user without blocking the user's field of view, stopping at a specified angle from the user's line of vision. As shown in FIG. 6, the 3D elements such as the AI drone 602, a virtual dashboard 604, a virtual handheld tablet 606, 3D graphs 608, in the VR world are placed to optimize user experience, ensuring accessibility and ease of interaction.

In an example implementation, the incident (as described in FIG. 1) can be resolved using the AI assistant drone 602. The user can also ask the AI assistant drone 602 for help in resolving incidents. by using voice commands. In an example, the user can request the AI assistant drone 602 by instructing the drone to create an incident by saying, “Hey App, resolve incident XV-12345” or by saying, “Hey Nexus, highlight critical incidents” and the AI drone 602 may respond visually/audibly to emphasize targeted nodes. Further, the AI assistant drone 602 can ask follow-up questions to gather necessary details and confirm the information. Further, the AI drone 602 can then generate the incident ticket and assign it to an analyst for resolution. This interactive approach enhances the user experience and ensures efficient handling of the security threat data.

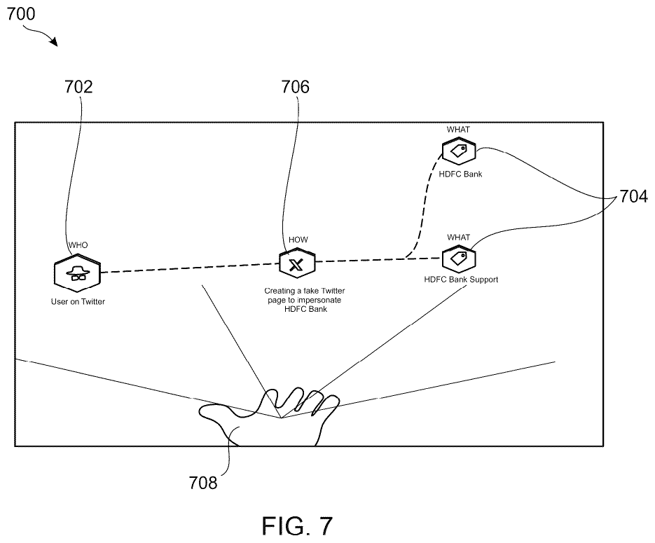

FIG. 7 illustrates a threat graph 700 for establishing interaction in the VR environment through the system 100. Threat graph 700 are configured to provide a clear, interactive visual representation of one or more cyber security threats, and detailing the relationships between one or more entities involved. Specifically, the threat graph 700 are configured to identify a source or actor 702 responsible for the one or more cyber security threat. The threat graphs 700 are further configured to specify the assets or entities 704 targeted or impacted by the one or more cyber security threat. In addition, the threat graph 700 are configured to outline the method or approach 706 used to execute the one or more cyber security threat.

In operation of the system 100, the threat graph 700 is configured to appear by the user interaction. At a first step, when the user extends at least one hand 708 (For example, right hand) forward with a palm of the at least one hand 708 facing in an upward direction, the threat graph 700 is configured to be dynamically projected onto their open palm with an accompanying animation. This intuitive gesture-based activation allows the user to instantly visualize and analyze cyber security threat data without additional menus or controls. At a second step, closing the palm smoothly dismisses the threat graph 700, which disappears through a complementary animation. Furthermore, throughout these interactions, the VR unit 108 of the system 100 is configured to provide distinct audio cues accompany the visual animations, providing clear, multisensory feedback to enhance user understanding and immersion.

This interactive operation significantly streamlines the user's ability to rapidly comprehend and respond to complex cyber security threat within the immersive VR environment.

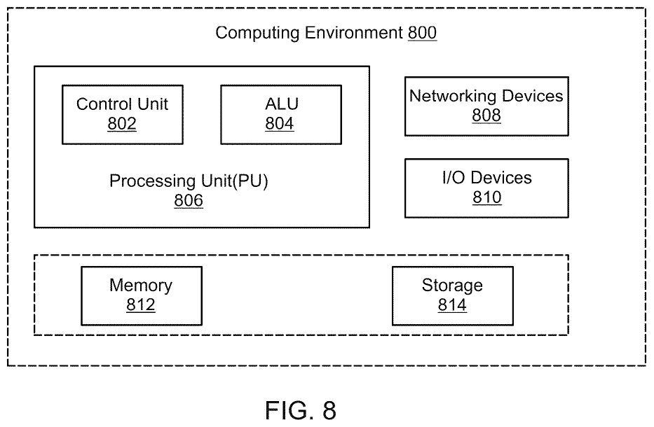

FIG. 8 illustrates an example computing environment 800 implementing the system 100, and method 300 as shown in FIGS. 2 and 3 for providing the user access to the security threat data in the virtual reality. As depicted in FIG. 8, the computing environment 800 comprises at least one data processing unit 806 that is equipped with a control module 802 and an Arithmetic Logic Unit, ALU 804, a plurality of networking devices 808 and a plurality Input output, I/O devices 810, a memory 812, a storage 814. The data processing module 806 may be responsible for implementing the system 100, and the method 300 as shown in FIGS. 2 and 3 respectively. For example, the data processing unit 706 in some embodiments is equivalent to the controlling circuitry of the platform described above in conjunction with FIGS. 2 and 3. The data processing unit 806 is capable of executing software instructions stored in memory 812. The data processing unit 806 receives commands from the control module 802 in order to perform its processing. Further, any logical and arithmetic operations involved in the execution of the instructions are computed with the help of the ALU 804.

The computer program is loadable into the data processing unit 806, which may, for example, be comprised in an electronic apparatus (such as the platform). When loaded into the data processing unit 806, the computer program may be stored in the memory 812 associated with or comprised in the data processing unit 806. According to some embodiments, the computer program may, when loaded into and run by the data processing module 806, cause execution of method steps according to, for example, any of the methods illustrated in FIGS. 2 and 3, or otherwise described herein.

The overall computing environment 800 may be composed of multiple homogeneous and/or heterogeneous cores, multiple CPUs of different kinds, special media and other accelerators. Further, the plurality of data processing unit 806 may be located on a single chip or over multiple chips.

The algorithm comprises instructions and codes required for the implementation are stored in either the memory 812 or the storage 814 or both. At the time of execution, the instructions may be fetched from the corresponding memory 812 and/or storage 814 and executed by the data processing unit 806.

In case of any hardware implementations, various networking devices 808 or external I/O devices 810 may be connected to the computing environment to support the implementation through the networking devices 808 and the I/O devices 810.

The embodiments disclosed herein can be implemented through at least one software program running on at least one hardware device and performing network management functions to control the elements. The elements shown in FIG. 8 include blocks which can be at least one of a hardware device, or a combination of hardware device and software module.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope of the present invention.

What is claimed is:

1. A system for providing a user with access to security threat data within a virtual reality (VR) environment, comprising:
a memory;
a processor configured to:
receive security threat data from one or more sources;
visually categorize, the received security threat data into one or more categories;
generate, a three-dimensional (3D) graphical representation of the categorized security threat data in the VR environment, wherein the 3D graphical representations of the security threat data are to be accessed by the user in the VR environment;
recognize, gesture data of the user requiring access to the 3D graphical representation of the security threat data; and
establish an interaction of the user with the 3D graphical representation of the security threat data in response to a recognition of a user gesture from the gesture data.

2. The system according to claim 1, wherein the processor is configured to:
prioritize security threats from the security threat data based on a predefined criteria, wherein the predefined criteria comprise at least one of: severity of the security threats, frequency, or potential impact, a financial loss calculation for the security threat data;
generate, the three-dimensional (3D) graphical representation of the categorized security threat data as per the prioritized security threats.

3. The system according to claim 1, wherein the one or more categories comprise at least one of: source surface-based categorization or attack surface based categorization.

4. The system according to claim 1, wherein the processor is configured to:
compare the user gesture with pre-stored gesture data that is stored in a database;
recognize the user gesture upon successful mapping of the user gesture with the pre-stored gesture data; and
establish the interaction of the user with the 3D graphical representation of the security threat data in response to the recognition of the user gesture.

5. The system according to claim 4, wherein processor is configured to:
receive user inputs to select, manipulate and analyze the 3D graphical representation of the security threat data, upon establishment of the interaction, wherein the user inputs comprise voice inputs, gesture inputs, user movement, image or video inputs, and wherein the voice inputs further comprise multi-action voice commands enabling the user to perform multiple operations through a single composite voice instruction.

6. The system according to claim 1, wherein the processor is configured to:
receive user inputs to prioritize the security threats in the 3D graphical representation of the security threat data upon establishment of the interaction, wherein the user inputs comprise voice inputs, gesture inputs, image or video inputs; and
generate one or more threat incidents as per the user inputs, wherein the one or more threat incidents are processed for remedial action.

7. The system according to claim 1, wherein the processor is configured to:
transmit feedback to the user in response to the receipt of the user inputs, wherein the feedback is one of: a voice feedback or a visual feedback, wherein the feedback comprises a response to a user's query, lack of clarity in the user inputs, or additional user inputs required to establish the interaction.

8. The system according to claim 1, wherein the user gestures, for selecting, zooming, and rotating the 3D graphical representations, comprise one or more of: grasping/grabbing, pinching, swiping, rotating hand/wrist and/or pointing gestures.

9. A method for providing a user with access to security threat data within a virtual reality (VR) environment, comprising:
receiving security threat data from one or more sources;
visually categorizing the received security threat data into one or more categories;
generating a three-dimensional (3D) graphical representation of the categorized security threat data in the VR environment, wherein the 3D graphical representations of the security threat data are to be accessed by the user in the VR environment;
recognizing gesture data of the user requiring access to the 3D graphical representation of the security threat data; and
establishing an interaction of the user with the 3D graphical representation of the security threat data in response to a recognition of a user gesture from the gesture data.

10. The method according to claim 9, comprising:
prioritizing security threats from the security threat data based on a predefined criteria, wherein the predefined criteria comprise at least one of: severity of the security threats, frequency, or potential impact, a financial loss calculation for the security threat data;
generating the three-dimensional (3D) graphical representation of the categorized security threat data as per the prioritized security threats.

11. The method according to claim 9, comprising:
comparing the user gesture with pre-stored gesture data that is stored in a database; and
recognizing the user gesture upon successful mapping of the gesture data with the pre-stored gesture data; and
establishing the interaction of the user with the 3D graphical representation of the security threat data in response to the recognition of the user gesture.

12. The method according to claim 9, comprising:
receiving, user inputs to select, manipulate and analyze the 3D graphical representation of the security threat data, upon establishment of the interaction, wherein the user inputs comprise voice inputs, gesture inputs, user movement, image or video inputs, and wherein the voice inputs comprise multi-action voice commands allowing the user to perform a plurality of tasks with a single composite voice instruction, including threat analysis, filtering, and visualization control.

13. The method according to claim 9, comprising:
receiving, user inputs to prioritize security threats in the 3D graphical representation of the security threat data upon establishment of the interaction, wherein the user inputs comprise voice inputs, gesture inputs, image or video input;
and generating, one or more threat incidents as per the user inputs, wherein the one or more threat incidents are processed for remedial actions.

14. The method according to claim 9, comprising:
transmitting feedback to the user in response to the receipt of the user inputs, wherein the feedback is one of: a voice feedback or a visual feedback, wherein the feedback comprises a response to a user's query, a lack of clarity in the user inputs, or additional user inputs required to establish the interaction.

15. The method according to claim 9, wherein the user gestures, for selecting, zooming, and rotating the 3D graphical representations, comprise one or more of: grasping/grabbing, pinching, swiping, rotating hand/wrist and/or pointing gestures.

16. A non-transitory computer readable storage medium storing instructions, which when executed, cause the processor to execute the method according to claim 9.
